(19) United States
(12) Patent Application Publication
(10) Pub. No.: US 2009/0310033 A1
(43) Pub. Date: Dec. 17, 2009

(54) TELEVISION AND METHOD FOR STORING DATA FILES THEREIN

(75) Inventors: LUNG DAI, Tu-Cheng (TW); SHAO-LIN ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/481,562

(22) Filed: Jun. 9, 2009

(30) Foreign Application Priority Data
Jun. 13, 2008 (CN) 200810302128.8

(51) Int. Cl. H04N 5/66

(52) U.S. Cl. 348/739; 348/E05.133

(57) ABSTRACT

A television includes a display unit, a speaker, a first function module and a second function module. The first function module is electrically connected with the display unit and the speaker is configured for receiving and reproducing broadcast television signals. The second function module is electrically connected with the display unit and the speaker is configured for processing files stored in the television, the second function module includes a memory, a playing unit, and a loading module. The memory provided stores the files. The playing unit electrically connected with the memory plays the files stored in the memory. The loading module electrically connected with the memory loads the files in a periphery device which communicates with the television and transmits the loaded files to the memory.

### BACKGROUND

1. Technical Field

The present disclosure relates to televisions, and particularly to a television capable of storing data files.

2. Description of Related Art

Televisions are devices which are configured for receiving and displaying television signals. Many televisions have other additional functions, such as playing audio or video signals provided from external media players. The external media players may be optical disc players, such as DVD players. When users want to use such additional function, they need to turn on the televisions together with the external media players. Furthermore, sometimes, to-be-played audio or video files selected by the users may be separately stored in two or more discs, so that the users may be need to change the discs in the media players. This is a convenience.

Therefore, there is room for improvement within the art.

### BRIEF DESCRIPTION OF THE DRAWINGS

FIG. 1 is a block diagram of a television in accordance with an exemplary embodiment.

FIG. 2 is a flowchart of a method for storing data files in a television in accordance with an exemplary embodiment.

### DETAILED DESCRIPTION

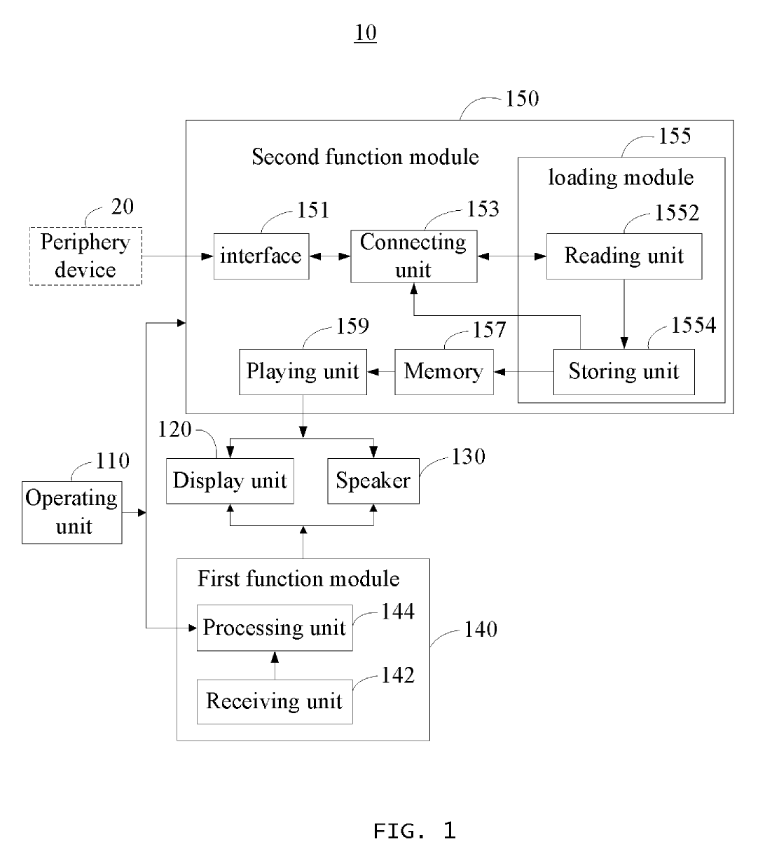

Referring to FIG. 1, a television 10 capable of playing television signals and audio or video files stored in the television 10 is provided. The television 10 includes an operating unit 110, a display unit 120, a speaker 130, a first function module 140 for reproducing the television signals, and a second function module 150 for processing audio or video files stored in the television 10. The operating unit 110 is controlled by users to selectively activate the first function module 140 and the second function module 150 to process the television signals or the files. The first and second function modules 140 and 150 further connect with the display unit 120 and the speaker 130 respectively.

The first function module 140 includes a receiving unit 142 and a processing unit 144. The receiving unit 142 is used for receiving broadcast television signals. The receiving unit 142 may be connected with a television cable (not shown) or wirelessly connected with a broadcast station (not shown). The processing unit 144 electrically connects with the receiving unit 142, the display unit 120, the speaker 130, and the operating unit 110. The processing unit 144 is activated by the operating unit 110 to convert the television signals, received by the receiving unit 142, to video signals and audio signals, and then transmit the video signals and audio signals to the display unit 120 and the speaker 130 respectively.

The second function module 150 includes an interface 151, a connecting unit 153, a memory 157 for storing a plurality of data files, a playing unit 159, and a loading module 155. The interface 151 is used for connecting a periphery device 20 to the television 10. The interface 151 may be a wired interface such as universal serial bus (USB) interface or a wireless interface such as mini PCI express interface. The periphery device 20 may be an external memory, such as a flash memory, a hard disc or a computer, which can be used for storing data files.

The connecting unit 153 is electrically connected with the interface 151 and loading module 155, is used for detecting whether the periphery device 20 is connected to the interface 151, and automatically establishing a communication between the periphery device 20 and the loading module 155 when the periphery device 20 is detected to be connected to the interface 151.

The connecting unit 153 has many detecting methods, such as detecting whether the periphery device 20 is inserted to the interface 151 when the wired interface is adopted, or detecting whether the periphery device 20 is in the predetermined range from the interface 151 when the wireless interface is adopted.

The loading module 155 electrically connects with the connecting unit 153 and the memory 157 for loading files from the periphery device 20 to the memory 157. The loading module includes a reading unit 1552 and a storing unit 1554 electrically connected with the reading unit 1552 and the memory 157. The reading unit 1552 is used for reading files in a predetermined format stored in the periphery device 20 and transmitting a copy signal to the storing unit 1554 when the files in the predetermined format are completely read. The predetermined format may be at least one of audio format such as MP3 and video format such as WMV.

The storing unit 1554 is used for storing the files read by the reading unit 1552 in the memory 157 responding to the copy signal. The storing unit 1554 generates a stopping signal when the files read by the reading unit 1552 are completely stored in the memory 157. A storing mode used by the storing unit 1554 may be an append mode or an overwrite mode.

The connection unit 153 also used for automatically stopping the communication between the periphery device 20 and the loading module 155 responding to the stopping signal, thus the periphery device 20 can be safely pulled out of the interface 151 of the television 10.

The playing unit 159 is activated by the operating unit 110 to play the files stored in the memory 157. Therefore, to-be-played audio or video files selected by the users can be stored in the memory 157 together. The users need not to change the discs in the media players in process of playing the to-be-played audio or video files. Thus this is convenient to the user.

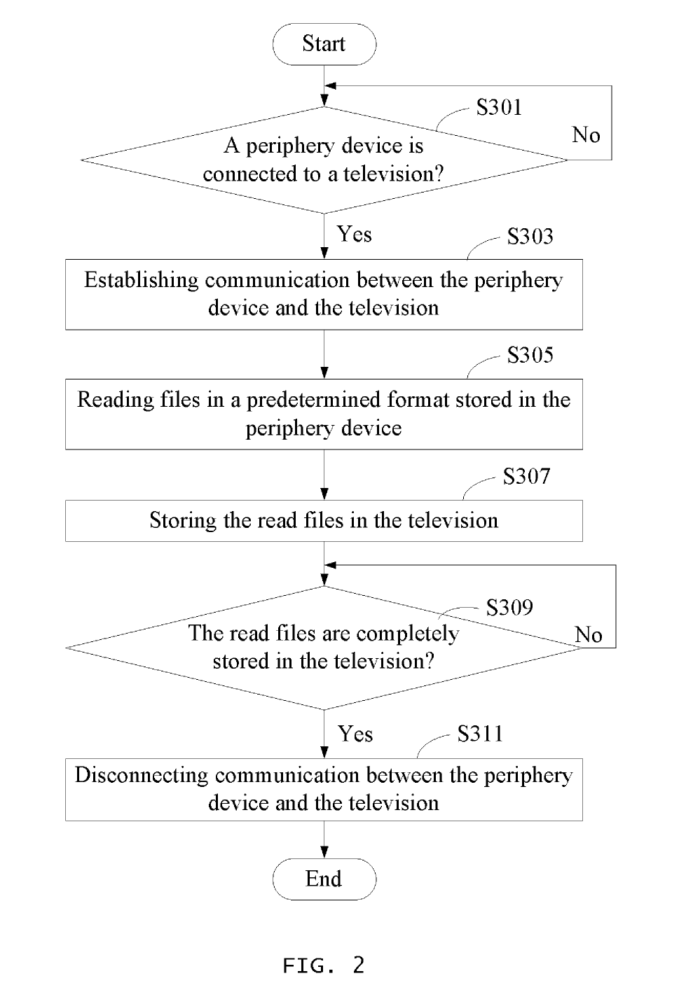

Referring to FIG. 2, a flowchart of a method for storing data files in a television in accordance with an exemplary embodiment is shown. The method may include the following steps.

In step S301, detecting whether a periphery device is connected to the television. If the periphery device is connected to the television, step S303 is implemented. If the periphery device is not connected to the television, return to step S301.

In step S303, establishing a communication between the periphery device and the television.

In step S305, reading files in a predetermined format stored in the periphery device. The predetermined format may be at least one of audio format such as MP3 and video format such as WMV.

In step S307, storing the read files in the television. A storing mode used is an append mode or an overwrite mode.

In step S309, detecting whether the read files have been stored in the television completely. If the read files are stored in the television completely, step S311 is implemented. If the read files are not stored in the television completely, return to step S309.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A television comprising:
a display unit;
a speaker;
a first function module electrically connected with the display unit and the speaker, the first function module configured for receiving and reproducing broadcast television signals; and
a second function module electrically connected with the display unit and the speaker, the second function module configured for processing files stored in the television, the second function module comprising:
a memory for storing the files;
a playing unit electrically connected with the memory for playing files stored in the memory; and
a loading module electrically connected with the memory, the loading module configured for loading files in a periphery device which communicates with the television and transmitting the loaded files to the memory.

2. The television according to claim 1, wherein the television comprises an interface capable of connecting with the periphery device and a connecting unit electrically connected with the interface and the loading module, the connecting unit detects whether the periphery device connects with the interface and establishes communication between the loading module and the periphery device when the periphery device connects with the interface.

3. The television according to claim 2, wherein the connecting unit stops communication between the periphery device and the loading module when the files from the periphery device are completely loaded to the memory.

4. The television according to claim 2, wherein the interface is a wired interface, the connecting unit detects whether periphery device is inserted in the interface and automatically establishing communication between the periphery device and the loading module when the periphery device is inserted into the interface.

5. The television according to claim 2, wherein the interface is a wireless interface, the connecting unit detects whether the periphery device is in the predetermined range from the interface, and automatically establishing communication between the periphery device and the loading module when the periphery device is in the predetermined range from the interface.

6. The television according to claim 1, wherein a loaded mode used by the loading module is an append mode.

7. The television according to claim 1, wherein a loaded mode used by the loading module is an overwrite mode.

8. A method for storing data files in a television comprising:
detecting whether a periphery device is connected to the television;
if the periphery device is connected to the television, establishing communication between the periphery device and the television; and
loading the files from the periphery device to the television.

9. The method according to claim 8, wherein that loading the files from the periphery device to the television comprises:
reading the files stored in the periphery device; and
storing the read files in the television.

10. The method according to claim 8, further comprising:
detecting whether the files in the periphery device are completely loaded; and
if the files in the periphery device are completely loaded, stopping communication between the periphery device and the television.

11. The method according to claim 10, further comprising:
if the files in the periphery device are not completely loaded, the step that the detecting whether the files in the periphery device are completely loaded is implemented.

12. The method according to claim 8, further comprising:
if the periphery device is not connected to the television, the step that detecting a periphery device is connected to the television is implemented.

13. A television comprising:
a display unit;
a speaker;
a first function module electrically connected with the display unit and the speaker, the first function module configured for receiving and reproducing broadcast television signals; and
a second function module electrically connected with the display unit and the speaker, the second function module configured for processing files stored in the television, the second function module comprising:
a communication module establishing communication between a periphery device and the television; and
a memory connected to the communication storing files in a predetermined format provided from the periphery device by the communication unit.

14. The television according to claim 13, wherein the communication unit stops communication between the periphery device and the television when the files in the predetermined format provided from the periphery device has completely stored in the memory.

15. The television according to claim 13, wherein the communication module comprises:
a connecting unit establishing communication between the periphery device and the television;
a reading unit reading the files in the predetermined format stored in the periphery device; and
a storing unit storing the read files in the memory.

16. The television according to claim 15, wherein the communication module comprises a wired interface being inserted by the periphery device.

17. The television according to claim 15, wherein the communication module also comprises a wireless interface connecting the periphery device to the television.

18. The television according to claim 13, wherein the files in the predetermined format provided from the periphery device are appended after the data files stored in the memory when communication between the periphery device and the television is established.

19. The television according to claim 13, wherein data files stored in the memory are overwritten by the files in the predetermined format provided from the periphery device when communication between the periphery device and the television is established.

20. The television according to claim 13, wherein the predetermined format may be at least one of audio format and video format.
